(19) United States
(12) Patent Application Publication
(10) Pub. No.: US 2026/0199174 A1
(43) Pub. Date: Jul. 16, 2026

(54) ROCKING CAM APPARATUS FOR ALTERNATING THE PRESSURE PATTERN OF A SUPPORT SURFACE

(71) Applicants: THE REGENTS OF THE UNIVERSITY OF CALIFORNIA, Oakland, CA (US); K MEDICAL LLC, Irvine, CA (US)

(72) Inventors: Jonathan Brigham Hopkins, Irvine, CA (US); Zhidi Yang, Poinciana, FL (US); James Langer Weida, Poway, CA (US); Siyuan Shao, Los Angeles, CA (US); Piyush Sheth, Irvine, CA (US)

(73) Assignees: THE REGENTS OF THE UNIVERSITY OF CALIFORNIA, Oakland, CA (US); K MEDICAL LLC, Irvine, CA (US)

(21) Appl. No.: 19/023,902

(22) Filed: Jan. 16, 2025

(51) Int. Cl. A61H 7/00; A61G 5/10; A61G 7/057; A61H 1/00

(52) U.S. Cl. CPC A61H 7/004; A61G 7/05707; A61H 1/003; A61G 5/1045; A61H 2201/0134; A61H 2201/0146; A61H 2201/0149; A61H 2201/1418; A61H 2201/1676; A61H 2201/1695

(57) ABSTRACT

A Rocking-Cam Alternating-Pressure (RCAP) support surface for periodically altering the pattern of applied pressure upon the person supported by the support surface. The support surface overlays a series of interconnected cam strips. Each cam strip contains a line of cams joined to a base member via revolute joints or similar mechanism. An actuation bar connects the cams so that they can be angularly disposed in a first or second direction, and thus change the pressure profile of the support surface. The support surface may be in the form of a mattress, a wheelchair cushion, or similar surface disposed over the cam strips.

### CROSS-REFERENCE TO RELATED APPLICATIONS

Not Applicable

### STATEMENT REGARDING FEDERALLY SPONSORED RESEARCH OR DEVELOPMENT

This invention was made with Government support under NR019721 awarded by the National Institutes of Health. The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

This technology pertains generally to personal support surfaces (e.g., bed mattresses, seat cushions, etc.), and more particularly to a rocking cam apparatus that can apply alternating pressure patterns to a support surface for purposes such as increasing a person's comfort, preventing injuries, providing a massaging motion, or providing a rocking motion.

### 2. Background Discussion

When a person/patient remains in a seated or supine position on a support surface for an extended period of time, there is a likelihood of developing injury, usually referred to as ‘bed sores’. These injuries are caused primarily by the occurrence of increased and constant pressure on the capillaries in the dermis of the skin that results in the prolonged blockage of blood flow. Contact pressures exceeding 32 mm of Hg for longer than two hours can lead to pressure sores. In the following discussions, the support surface is exemplified as being a bed mattress for laying and a seat cushion for sitting, although this is applicable to any surface upon which a portion of the body of a person/patient (or animal) is supported for an extended period of time.

Regardless of the support surface being discussed, it is important that the person/patient be regularly repositioned. In regard to those lying on hospital beds, the current hospital protocol is to turn the patient every two hours. However, this repositioning requirement not only disturbs and awakens sleeping patients, but it may also cause maceration due to the shear forces experienced by the often fragile and sensitive skin of the patient. Repositioning can also be a liability for the nurses who have to turn the patient, which may be overweight and difficult to move.

Accordingly, there is a need for engineered support surfaces that are effective at limiting the occurrence of pressure injuries, while simplifying the repositioning of applied pressure, and being relatively inexpensive and durable to own and maintain.

### BRIEF SUMMARY

This disclosure describes a mechanism for periodically altering the pattern of pressure applied to a bed-bound person/patient that uses rocking cam mechanisms to alter the pattern. We refer to this mechanism in this disclosure as a “Rocking-Cam Alternating-Pressure (RCAP)” support surface.

In at least one embodiment, a series of planar parallelogram linkages are moved by an actuation bar, which connects rotatably to the same location on each rocking cam. The bottom of each rocking cam is coupled to a base portion by a revolute joint. This revolute joint can be a standard revolute joint or flexible straps or a living hinge or a ball bearing or any similar mechanism. The rocking cams can be shaped in various profiles (e.g., two-dimensional), such as cardioid shape (i.e., heart shaped), rounded diamond shape, or other suitable geometric shapes which provide a differently positioned point of contact, such as within the plane of the panel, when the cams traverse from leaning in a first orientation to leaning in an opposing orientation, toward changing the pattern of pressure applied to a person/patient in contact with the RCAP support surface (e.g., lying on a mattress, or sitting on a seat cushion) disposed over this apparatus of planar parallelogram linkages.

Various uses the apparatus can include, but are not limited to, increasing a person's comfort, reducing or preventing pressure injuries to a person lying or sitting on the described support surface, providing massage therapy to a person lying or sitting on the described support surface, or providing side-to-side rocking motion which comforts the person to the person sleep or to calm the person.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1A and FIG. 1B are front views of a portion of a cam strip for assembling a RCAP support surface, according to at least one embodiment of the present disclosure.

FIG. 2A through FIG. 2I are front and pictorial views of operating the RCAP support structure utilizing the cam strips shown in FIG. 1A, according to at least one embodiment of the present disclosure.

FIG. 3 is a front view of a single-piece version of the cam strip shown in FIG. 1A, according to at least one embodiment of the present disclosure.

FIG. 4A through FIG. 4C are front views of the cam strip of FIG. 1A, which incorporates balancing springs, according to at least one embodiment of the present disclosure.

FIG. 5A and FIG. 5B are front views of the cam strip shown in FIG. 1A shown connected with an actuator to control positioning of the rocking cams, according to at least one embodiment of the present disclosure.

FIG. 6A through FIG. 6D are side and pictorial views of a cam strip connection frame having multiple revolute joints to accommodate use on articulating bedframes, according to at least one embodiment of the present disclosure.

FIG. 7A and FIG. 7B are a front view of applied moments to the heart-shaped cams of FIG. 1A, according to at least one embodiment of the present disclosure.

FIG. 8A and FIG. 8B are plan views of diamond-shaped cams, such as seen in FIG. 1B, according to at least one embodiment of the present disclosure.

FIG. 8C through FIG. 8E are pictorial views of the cams of FIG. 1B showing offset phasing of cams between adjacent cam strips, according to at least one embodiment of the present disclosure.

FIG. 9A through FIG. 9D are front views of a cam strip with diamond-shaped cams, which are configured with balancing springs, according to at least one embodiment of the present disclosure.

FIG. 10A through FIG. 10C are front views of a portion of a cam strip utilizing a living hinge, support walls, and optional balancing springs, according to at least one embodiment of the present disclosure.

FIG. 11 through FIG. 11C are pictorial views of movement of the cam strips interconnected with bars, according to at least one embodiment of the present disclosure.

FIG. 12A through FIG. 12E are pictorial views of a variation of the cam strips interconnected with bars, according to at least one embodiment of the present disclosure.

### DETAILED DESCRIPTION

### 1. Introduction

The present disclosure describes a Rocking-Cam Alternating-Pressure (RCAP) support surface that can be used to, for example, increase a person's comfort, reduce or prevent pressure injuries, provide massage therapy, or provide side-to-side rocking motion which comforts the person to the person sleep or to calm the person. The foregoing uses are non-limiting examples of possible uses of the apparatus. In one embodiment, a support structure according to this disclosure typically comprises parallel sets of cam strips, to span any desired length and width, over which a pad (e.g., seat pad/mattress pad) would normally be retained between the RCAP support surface and the person/patient whose weight is being supported.

The basic unit of this disclosure is that of the cam strip. Each cam strip having a base member upon which a plurality of rocking cams are pivotally attached at a revolute joint, allowing each cam to rock between different positions, including first and second positions at the two ends of travel for the cam member. The cams, or one or more groups of the cams, are coupled to an actuation bar attached to multiple cams. The four revolute joints across each pair of cams and its base member and actuation bar form a parallelogram having a vertical height which is at a minimum at first and second end points of cam travel.

In response to movement of the actuation bar, the multiple connected cams are moved in unison from a first position to a second position, thus altering the pressure profile on RCAP support surface. In at least one embodiment, the parallel cam strips can be joined together, such as by interconnect bars connecting rocking cams, positioned orthogonally to the cam strip, to one another wherein these parallel cams move in unison with the movement of the actuation bar. These interconnect bars may incorporate a cylindrical pad about their exterior.

It will be noted that each rocking cam comprises a geometric shape which provides a differently positioned pressure point when the cams traverse from leaning in a first orientation to leaning in an opposing orientation. By way of example and limitation, two preferred shapes are a cardioid shape, and a diamond shape.

The base of the cam strip is configured for connecting each of the rocking cams via a revolute joint or a similar mechanism and providing a first contact position on the hard stop of the base when the cam rests on first side, and a second contact position on the hard stop of the base when the cam rests on the second side. In at least one embodiment the base has stops to further limit the angular travel of each rocking cam.

Below exemplifies a few of the ways that the teachings of the present disclosure for the heart/diamond cam based checkerboard design is different from the checkerboard trapezoid design that was originally patented. The present disclosure utilizes cams that can be shaped to achieve custom surfaces that tailor the nature of the pressure imparted on the patient whereas the previous design is limited to imparting an edge support on the patient. Additionally, the cams achieve rolling motion relative to the patient thus reducing the shearing forces on their skin. The design of the original patent can subject the patient to higher levels of friction since the edge rotates below them as they rock back and forth. The present disclosure leverages simpler kinematics of a parallelogram mechanism, whereas the previous trapezoid mechanism uses the more complex geometry, which requires extra links, degrees of freedom, and extending bars to function. The present disclosure does not require any links to extend and it achieves the kinematics with a single degree of freedom. The present disclosure can be manually actuated more simply since its actuator bars translate back and forth the same amount between panels and thus can be linked together by convenient handles that stabilize the mechanism further and make it easy to push and pull the mattress back and forth. The present disclosure uses different revolute joints along its sides to enable the mattress to raise and lower, instead of flexure joints of which more were required. The present disclosure supports the use of lateral designs with lateral or longitudinal bars, which could not be supported in the previous design. A wider range of versions of the present disclosure can be implemented because of its dramatically simplified kinematics.

### 2. Embodiments

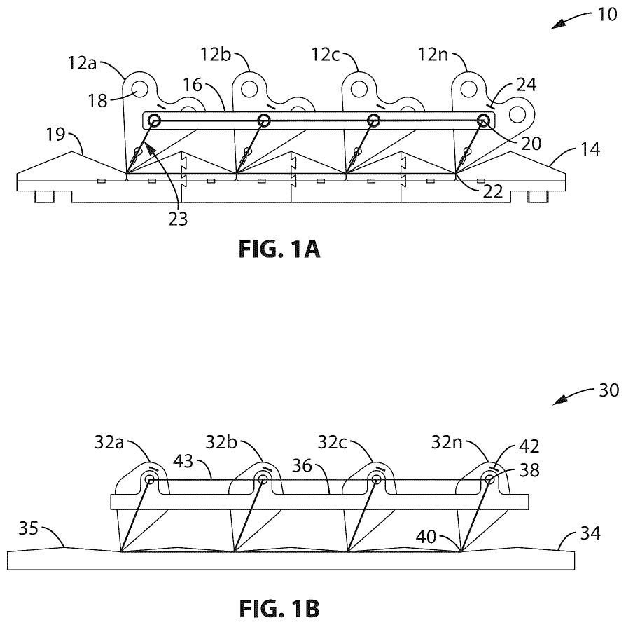

FIG. 1A and FIG. 1B illustrate example embodiments 10, 30 of cam strips for assembling a Rocking-Cam Alternating-Pressure (RCAP) support surface according to the present disclosure.

In FIG. 1A is shown a base 14 upon which are attached multiple rocking cams 12a, 12b, 12c, through 12n. For the sake of simplicity of illustration, the cam strip is exemplified having four cardioid shaped rocking cams, although each strip may contain any desired number of cams. In at least one embodiment the bases of the cam strips can interconnect, allowing assembling them into cam strips of any desire length. In FIG. 1A a base 19 is shown which interconnects at a macro level, while also showing segmentation at a lower level, whereas FIG. 1B depicts a single base 35. It should be appreciated that the base, or bases, may be configured for joining to one another in any desired mechanical fastening manner, or be configured as single bases, without departing from the teachings of the present disclosure.

Each of these cams is attached to base section 14, and is also attached to an actuation bar 16, through revolute joints (rotatable) 20, 22. These joint positions between adjacent rocking cams forms a series of planar parallelograms 23. In at least one embodiment, each cam is configured with one or more apertures, herein exemplified as a pair of circular holes 18 in each cam for attachments of column bars, as described in a later section. In addition, strap slits 24 are shown for attaching the cams to cams on adjacent cam strips. In at least one embodiment, the base of the cam strips has raised portions 19, which reduce the amount of cam travel between their first and second end of travel positions. In at least one implementation, these raised portions are configured to provide a large contact area with the cam when it is at the end of its travel to distribute the force applied between the cam and base. It will be appreciated that the cams move in an arcing path in view of the revolute joint connection to the base.

In FIG. 1B is shown a cam strip 30 using cams having a different geometric shape, exemplified as being diamond shapes having upper corners rounded to provide a smooth interface to padding material of a seat pad or mattress. The rocking cams 32a, 32b, 32c through 32n are each shown connecting through revolute joints 40 to base member 34.

For the sake of simplicity of illustration, the cam strip is shown with only four cams, although each strip may contain any desired number of cams, and in at least one embodiment the bases of the cam strips can interconnect, allowing assembly of extended cam strips to any desire length.

An actuation bar 36 connects a number of the cams, in the case shown as being between cam 32a and 32n. In the illustration this is shown as a four-bar linkage. Actuation bar 36 connects with each cam at a revolute joint 38. It will be noted that in this specific example the connection points in the actuation bar are offset from the center line of the actuation bar, toward preventing any portion of the actuation bar from extending beyond the pits of the checkerboard that are formed by the cams at any point in the travel of the cams, which if not prevented can eliminate the pit and therefore not make a checkerboard pressure pattern. In addition, or alternatively, if the underside of the cam bar is sufficiently extended downward, in relation to the position of revolute joint 38, it can be used to limit travel of the cams in their two end positions on either side of their attachment 40 to the base. Also, alternatively, hard stops can be provided on either end of the base extending vertically from the cam strip to limit the travel of the actuation bar which is extended horizontally on either side. Alternatively, as in FIG. 1A, the rocking cams can be configured to contact the base 34 at this first and second end of travel positions. In this case the base can be configured with raised portions 35 to alter the angle through which the cams are allowed to travel. The figure depicts that between each pair of cams a parallelogram is formed of the revolute joints, and the parallelogram has its lowest height at the two ends of rocking cam travel. In addition, the cams are shown with optional strap slits 42 for attaching the cams to cams on adjacent cam strips.

These diamond shaped cams are configured to be displaced between a first position and a second position, with each traversal alternating the pressure applied to a person sitting or lying on the support structure.

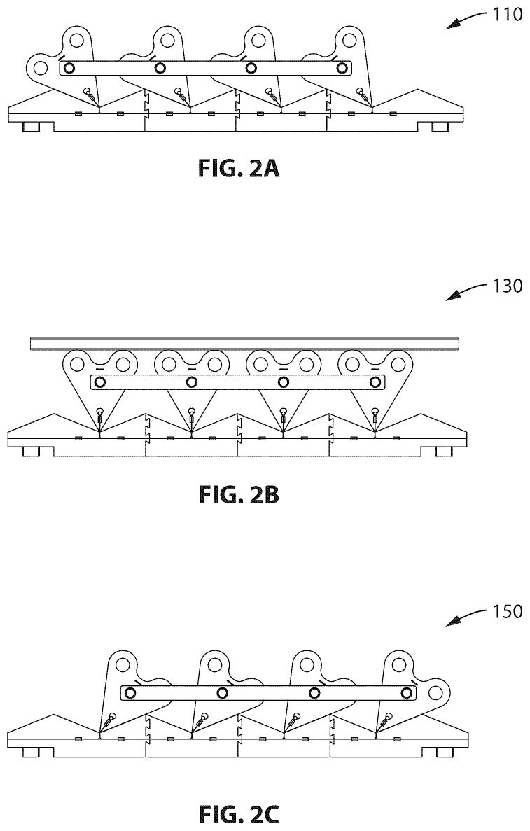

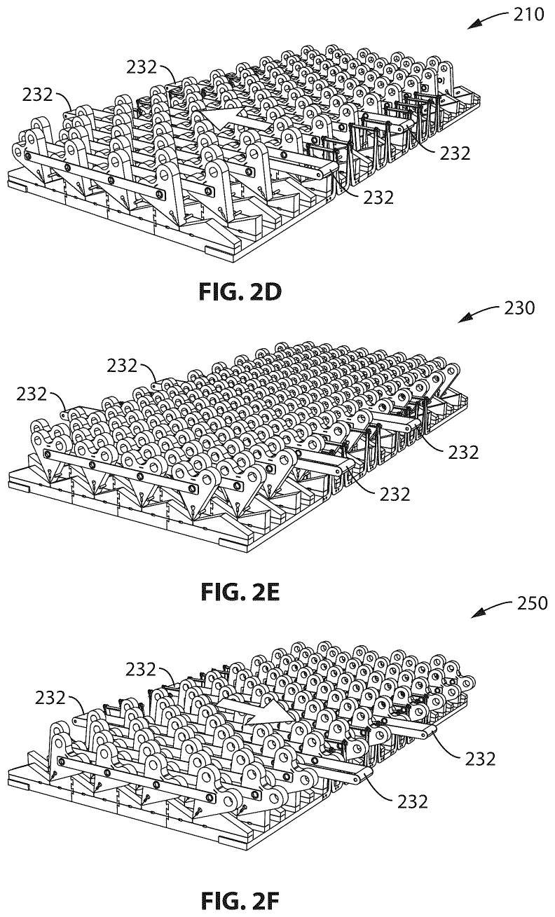

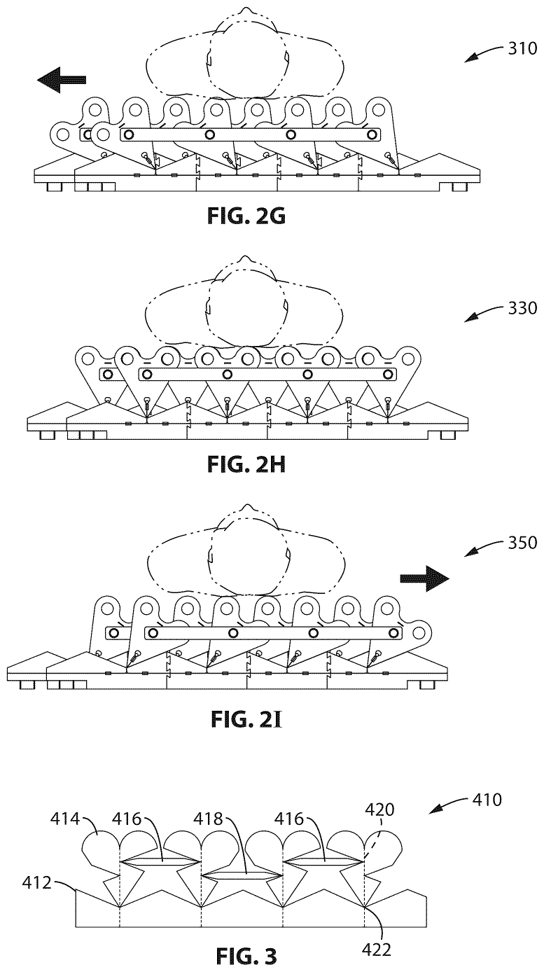

FIG. 2A through FIG. 2I illustrate the operation of the cam strips, shown individually in FIG. 2A through FIG. 2C, formed in a wider support structure in FIG. 2D through FIG. 2F, and shown in a front (edge) view supporting a patient in FIG. 2G through FIG. 2I (padding between the patient and cam strips was not shown for the sake of clarity), which are shown moving (rocking) between a first position (left leaning cams) 110, 210, 310, to a center position 130, 230, 330, and to a second position (right leaning cams) 150, 250, 350. The first and second positions are considered when the cams engage mechanical hard-stops as they tilt fully to the right, or to the left.

In FIG. 2D through FIG. 2I of this embodiment, it can be seen that these heart-shaped cam strips are arranged out of phase with one another, which results in the high protruding parts of the cams exhibiting a checkerboard pattern when the cams are moved to their left and right side static positions.

It should be appreciated that the support surface, although shown as a mattress based mechanism, can also be configured in a seat (bottom and/or back), such as for a wheelchair, or other structure for supporting at least a portion of the weight of a person/patient (or animal). The resulting pressure pattern of these rocking cams manifests different pressure patterns, depending on the arrangement and phase relationships of the cam strips. In each case the disclosure allows a rapid and simple mechanism for alternating the location of protruding peaks and pits on the surface, and thus moving the locations where support pressure is applied.

In the front view of the support surface seen in FIG. 2G through FIG. 2I, the person is shown lying on the support structure in its three stable configurations.

In at least one embodiment, the mass of the linkage elements could be removed and replaced with bracing to help make the linkage lighter weight and more moldable (for injection molding for instance). It should be appreciated, for example, that the linkage between elements can be truss like and not a contiguous solid to reduce weight and material cost. Alternately, it can be hollow part or shelled with ribs or without ribs, removing material and additionally saving material cost.

If multiple cam strips are placed back-to-back as shown in FIG. 2D through FIG. 2F where the heart-shaped cams of one linkage are out of phase with the heart-shaped cams of the neighboring cam strip (i.e., the points at the bottom of the heart-shaped cams on one linkage are spaced half-way between the points at the bottom of the cams on the linkage in front or behind it) and those two different kinds of out-of-phase linkages alternate one after the other, a support surface (i.e., mattress or seat/wheelchair cushion) is created that imparts a checkerboard-like pressure pattern on anyone lying or sitting on it.

In other words, if a person were lying on the support surface with the cams leaning on their left-sides, and then the mattress were actuated with its cams leaning on their right-sides, then the pressure peaks in one configuration imparted on the person would become the pressure pits (lulls) of the other configuration and vice versa (i.e., in one configuration the dark squares of the checkerboard would be up while the light squares would be down and then the light squares would go up and the dark squares would go down in the next configuration).

In at least one embodiment, the person rocks back and forth with the top surface of the support surface, as it is actuated back and forth according to the embodiment of FIG. 2A through FIG. 2I. However, toward preventing slip and any possible shearing forces on the skin of the person, in one option, the cams are configured with high-friction strips over the top surface of the cams. Any such shearing forces would be further reduced by placing a foam pad between the person and the disclosed support surface.

Different sets of actuation bars (to different cam strips) could also be joined together by connector handles 232 as seen in FIG. 2D through FIG. 2F, that could be used by caregivers to pull or push the support surface back and forth between its two alternating-pressure configurations (i.e., from the left-side configuration to the right-side configuration). The cams from one linkage would be joined to the cams of the other linkages by straps which interconnect with cams of adjacent cam strips, for example by using strap retaining structures for retaining straps at each cam, which is exemplified herein by threading fabric straps through strap slits 24 in FIG. 1A within each cam.

In at least one embodiment, the ‘handles’ can serve additional purposes. For example, the handles also can provide rigid links between panels, dramatically reducing the ‘slop’ of the bed and ensuring a consistent clean actuation (regardless of actuation by caregiver or by linear actuators). Still further, the handles can be useful in performing static balancing, since more independent of providing exact positioning of static balancing springs.

FIG. 3 illustrates an example embodiment 410 of a single-piece version of the cam strip shown in FIG. 1A, this single-piece version is made from a single material that achieves the desired kinematics via deformation of thin portions of the part (i.e., living hinges that behave as revolute joints). In this embodiment, the base 412 and the cams 414 are formed as a single part connected with living hinge material 420 in the cams to the hinge point 422, and in at least one embodiment extending into the base material for retention.

It should be appreciated that this single-part embodiment may be practiced with cams of any desired shape, insofar as the proper recesses can be provided for accepting the actuation bars, or similar actuation mechanisms, between each pair of cams.

The linkages between cams could be provided with the actuation bar as in FIG. 1A, and which would allow the use of the same cam geometry as in FIG. 1A. However, in at least one embodiment, such as shown in the figure, the linkage between cams is using bar segments also formed in this one piece, shown with alternating high 416 and low 418 (bar segment) linkage placement, with associated recesses into which the bar segments interface with the rocking cams 414.

Accordingly, this single part can be fabricated using one piece of material with compliant hinges as shown in FIG. 3 that behaves the same way as the multi-part linkage design of FIG. 1A. In the case of the single-part design of FIG. 3, its revolute joints are achieved via the deformation of thin compliant living hinges. For the actuation bars in FIG. 3 to rock the cams so that they remain parallel without the bars themselves needing to extend, they connect along straight lines that pass through the revolute joint 420, to allow moving the cams in relation to revolute joint 422. Thus, the actuation bars need to be staggered from one cam to the next as shown in FIG. 3 so that the cams remain rigid themselves.

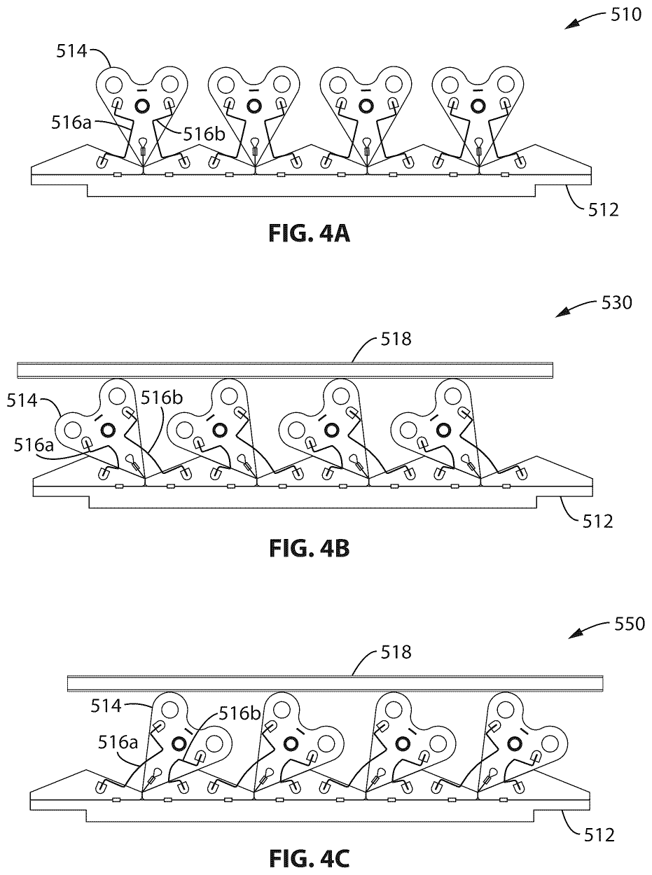

FIG. 4A through FIG. 4C illustrate an example embodiment showing use of balancing springs, which are shown in these figures, in a no-load condition 510 in FIG. 4A, under force to a full left leaning position 530 in FIG. 4B, and then in a full right leaning position 550 in FIG. 4C. In the example shown, the springs 516a, 516b are illustrated as being attached to the back side of the linkage from the base 512 to the cams 514, although springs may be located at any desired location. In this example a pair of springs are coupled between each cam and the sections of the base member to which the cam is attached. Under load, as seen in FIG. 4B and FIG. 4C, one spring of the pair is in compression, while the other spring is in tension. It should also be appreciated that embodiment may be implemented with a single or multiple springs for each one or more cams.

These springs are configured to resist the weight of the person lying or sitting on top of the cams as well as the weight of the linkage itself when the linkage is actuated to its left-side configuration 530 in FIG. 4B and to its right-side configuration 550 in FIG. 4C, thus reducing the force required to shift the linkage back and forth when the body weight of a person presses down on the mattress which is over the disclosed RCAP support surface.

These springs are made from any suitable flexible materials, such as spring-steel ribbon material formed into the desired shapes. In order to adjust the disclosed support surface for a given weight of the person, springs with different force constants (e.g., thicker spring steel), may be utilized, and/or the use of additional springs (e.g., pairs of springs and so forth), and/or springs with different geometries.

As seen in FIG. 4A through FIG. 4C the balancing springs are attached from the base to each of the cams, with it being assumed that on the other side of the cams is where the actuation bar is attached. As the cams are tilted either to the left-side configuration in FIG. 4B, or to the right-side configuration in FIG. 4C, the balancing springs deform to resist the motion and thereby counteract the weight of the person on top as well as the weight of the heart-shaped cams and actuation bar themselves. Thus, if balanced properly to the weight of the person lying or sitting on top, the resulting support surface would require minimal actuation energy to alternate the intended pressure pattern. It should be appreciated that all embodiments of the present disclosure can be configured for using balancing springs, such as those seen in FIG. 1B, and FIG. 3.

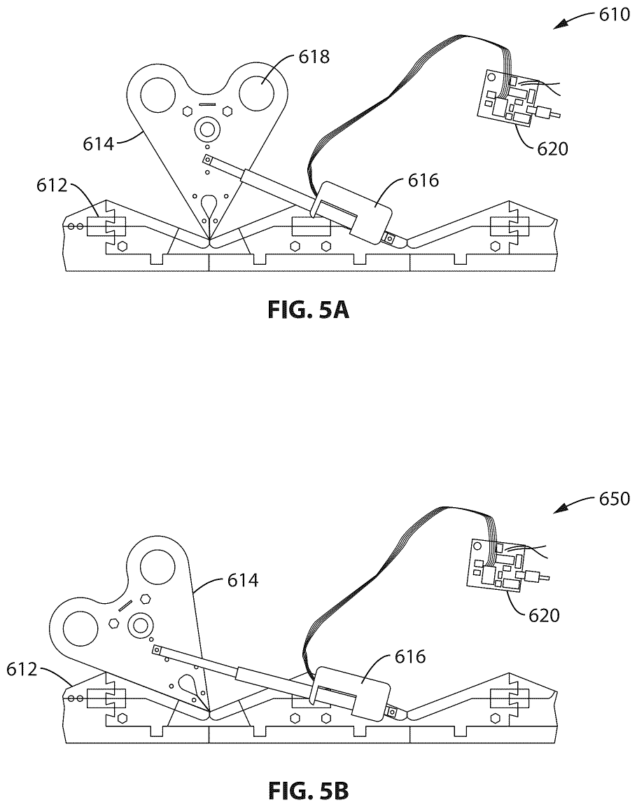

FIG. 5A and FIG. 5B illustrate an example embodiment of using an actuator for controlling the positioning 610, 650 of the rocking cams. In FIG. 5A the actuator 616 is retaining rocking cam 614 in a centered (vertical) position, while in FIG. 5B depicts the actuator 616 has driven the cam 614 to a first leaning position in contact with base 612.

Once properly balanced, such as by using springs as described earlier, it will be appreciated that the resulting support surface could not only be actuated manually by a caregiver by pulling, or pushing, on the connector handles, as labeled in FIG. 2B, but the pressure points of the support surface could also be actively repositioned by actuators attached to the linkage as shown in FIG. 5A and FIG. 5B. If the support surface is properly outfitted with balancing springs, the support surface could be actuated back and forth with one or more actuators while a person lies or sits on top. It should also be appreciated that actuators may be similarly applied to the other embodiments described herein.

The example shows the use of a single actuator; however, any desired number of actuators may be utilized. The number of actuators utilized is dependent on the size of the actuators and the desired operation. For example, a single actuator can be utilized to drive a cam, which by virtue of its connection through an actuation bar along this same row of cams, controls all the cams in this row. Then, by virtue of these cams being connected to other rows of cams, such as through straps interconnecting between rows of cams, the entire surface can be actuated to move the cams to any desired position along their travel. In addition, in at least one embodiment having handles as previously described, the handles may be utilized to stiffen interconnection between cam rows, or for an actuator connection point, or points.

However, in at least one embodiment, multiple actuators are utilized and distributed, such as one actuator for each ‘n’ rows of cam strips. In using multiple actuators, the force requirements are lessened for each actuator. In addition, using distributed actuators may provide for smoother cam movements, since the straps from a single row are not subject to the full force required to move all the cams.

In at least one embodiment, the actuators utilized are linear actuators, which extend and retract in response instructions from a controller 620, such as a control circuit and associated electrical driver circuit which provides the driving signals to the motor in the electrical actuator(s). It should be recognized, however, that actuators of other forms may be utilized without departing from the teachings of the present disclosure, such as rotary actuators, angular actuators, cable based actuators, and so forth, insofar as they are properly coupled into the cams, and can be controlled to move between at least the first and second positions of the cams. It should also be noted that although electrical actuation is perhaps the simplest, the actuators could alternatively be driven pneumatically, hydraulically, gravity based (no electrical power requirement) mechanism or even piezoelectrically, depending on the specific application and environmental factors.

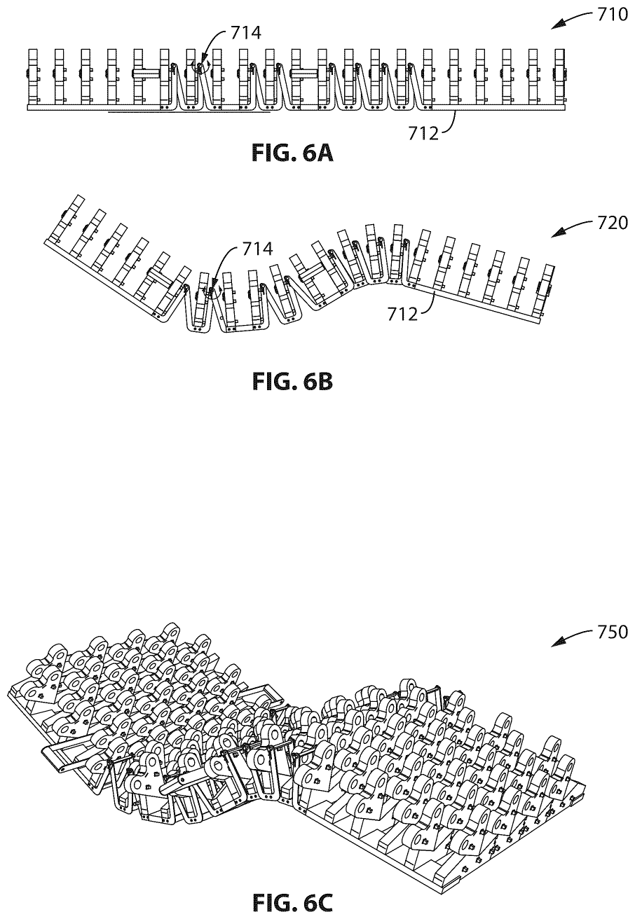

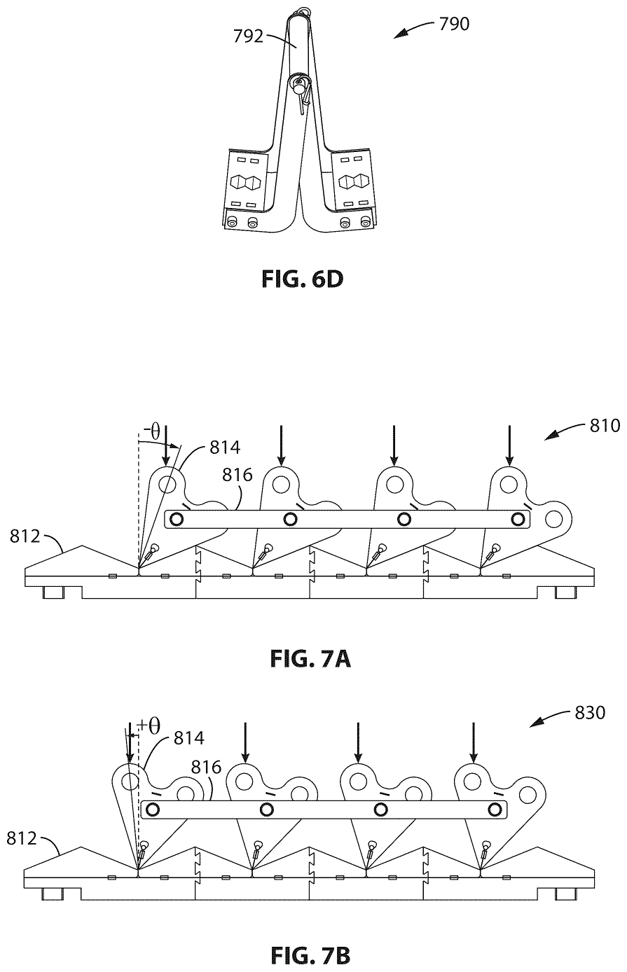

FIG. 6A through FIG. 6D illustrate an embodiment in which a plurality of cam strips are coupled into a connection frame which is configured for flexing to accommodate being used on an articulating bedframe, having one or more hinged sections.

In FIG. 6A and FIG. 6B the row connection frame is shown in a side view in a flat orientation 710, and in flexed configuration 720, such as to fit an articulating bedframe. The cam strip connection frame is configured for retaining a plurality of cam strips, and is shown having multiple specially placed revolute joints 714, that allow the disclosed support surface to flex in either direction. It will be seen in view 720, that one portion of the cam strip connection frame is flexed in a direction which reduces the spaces between cam rows, while another portion of the cam strip connection frame is shown flexed in an opposite direction which opens the spaces between the cam rows. In FIG. 6C is shown a perspective view 750 of the cam strip connection frame 720 shown in FIG. 6B. In FIG. 6D is a closeup view of a single revolute joint 790 with its hinge 792, with its smooth cover section.

Embodiments may be created of different cam strip connection frames for use with different types of bedframes, whether flat, or having one or more articulating sections. Each of these cam strip connection frames can be populated with any of the described cam strips. Revolute joints can be used at certain locations between the linkages along the length of the support surface to accommodate various bedframes, for example, that raise and lower head and leg portions. These revolute joints can be placed on either side of the support surface so that they do not interfere with persons lying on top. The closer the axis of the rotational hinge is located near the top surface of its linkages when they are actuated to their left-side or right-side configurations, the less shearing or pinching forces will be experienced on the person's skin as the bedframe is raised and lowered, and the less the checkerboard pressure pattern desired will be adversely affected. It should be appreciated that these revolute joints do not affect the support surface's ability to alternate its pressure pattern from pressure peaks to pits and vice-versa when the linkages are actuated back and forth from their left-side configuration to their right-side configuration regardless of whether the bedframe's head and knee portions are raised or lowered.

Accordingly, the disclosed cam strip connection frame allows the disclosed support surface to flex in either direction to accommodate a bedframe being raised or lowered at specific locations without affecting the support surface's ability to alternate its checkerboard-like pressure patterns.

FIG. 7A and FIG. 7B illustrate the heart-shaped cams 814 of FIG. 1A and depicting 810, 830 downward ‘patient’ forces in relation to the geometry of the cams. In FIG. 7A, the downward forces generate a moment having an angular displacement of −⊖ from the vertical, which pushes the right-leaning cams against the base structure in this diagram. In FIG. 7B the applied moment is very slightly in the +⊖ direction, which would drive the cams toward the left.

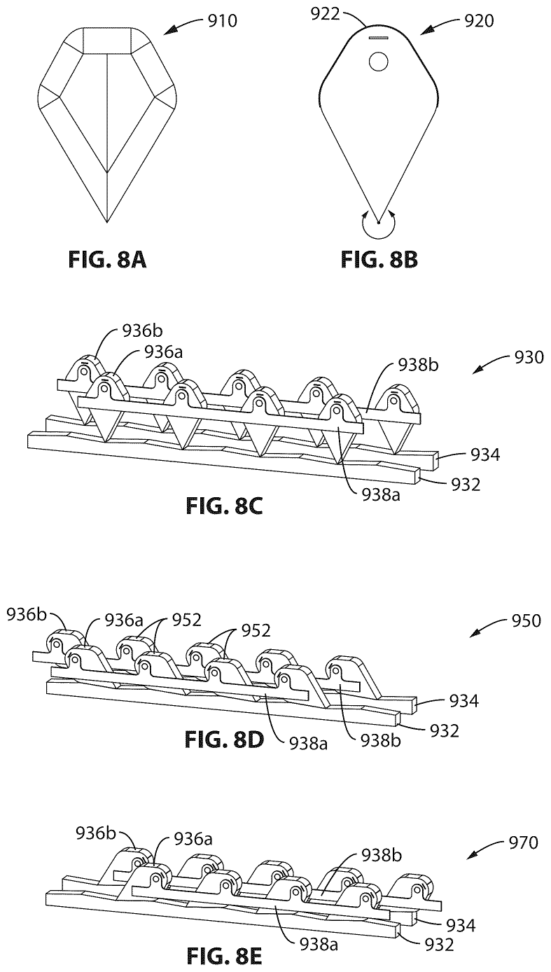

Different cam shapes behave in different ways. The heart-shaped cams of FIG. 7A and FIG. 7B, for example, exhibit three stable states when a person lies on top of them (i.e., left-side configuration, central configuration, and right-side configuration). It should be noted that if the angle between the black vertical line in FIG. 7A and the line that passes through the point at the bottom of the heart and the point at the center of the circle of the loaded heart hump is a negative value (i.e., it is rotated clockwise), the load from the person's weight will create a moment load that keeps the heart-shaped cam stable against its hard stop. If, however, that angle is positive (i.e., it is rotated counterclockwise as shown in FIG. 7B), the load from the person's weight will create a moment load that stabilizes the heart-shaped cam back to its central configuration. Different cam shapes, however, such as the diamond shape of FIG. 8A through FIG. 8C would only be stable in the two desired states of alternating pressure (i.e., left-side configuration of FIG. 8D and right-side configuration of FIG. 8E).

FIG. 8A through FIG. 8E illustrate another example of different cam shapes, along with an example of offset phasing of the cams between adjacent cam strips. In FIG. 8A is depicted a diamond-shaped cam 910 that can be used to alternate a checkerboard-like pressure profile on a person lying or sitting on them. In FIG. 8B is depicted an optimized version 920 of the general diamond design having a high-friction strip 922 on the portions of its periphery configured for making contact with the padding between the cams and the person lying or sitting on the disclosed support structure, to facilitate that the exterior will move without slipping from the padding.

In FIG. 8C through FIG. 8E is illustrated two out of phase cam strips using the diamond-shaped cams. The cam strips are said to be out of phase in that the cams on the second cam strip are not aligned longitudinally to the cams on the first cam strip. Typically, the out of phase distance is half of the spacing. As a result of repeating this same out of phase positioning of adjacent cam strips a checkerboard pressure pattern is provided in supporting the person.

Specifically, two cam strips are shown in this set of figures, the first strip is shown with cams 936a over base 932 and using an actuation bar 938a, while a second strip is shown with cams 936b over base 934 and using an actuation bar 938b. The out of phase cams would be repeated across the breadth of the disclosed support structure to create the full support surface, whose cams are shown positioned in a central configuration 930 in FIG. 8C, a left-leaning 950 position in FIG. 8D, and a right-leaning position 970 in FIG. 8E. It should be appreciated that these diamond-shaped cams are only stable in their left-side and right-side end-of-travel positions and that when they are in those positions, the person lying or sitting on them experiences a much lower peak pressure compared with the heart-shaped cams due to the flat surfaces 952 shown in FIG. 8D.

Different cam shapes, such as these diamond shape cams are only stable in the two desired states of alternating pressure (i.e., the left-side cam position shown in FIG. 8D and the right-side cam position configuration shown in FIG. 8E. Also, unlike the heart-shaped cams that always impart a line-contact peak pressure from a half cylinder on the person lying or sitting on them, the diamond-shaped cams would only impart such line-contact peak pressures while they are transitioning from one stable state to the next as they are actuated. When, however, they are resting in their stable left-side or right-side states, the diamond-shaped cams impart a much larger area-contact from their flat surfaces. Thus, the peak pressures experienced by the person in the left-side and right-side configurations using the diamond-shaped cams are substantially lower than the peak pressures experienced by the heart-shaped cams. In contrast, however, the diamond-shaped cams need to both rock the person and roll them over a larger range of travel than the heart-shaped cams to function properly. It should be appreciated that the high-friction strips 922 of FIG. 8B facilitate this rolling while minimizing shearing loads from slipping. It should also be noted that the cam design of FIG. 8B is an optimized version of the general parameterized diamond design of FIG. 8A. Finally, it should be noted that the cam shapes shown in FIG. 3 do not need to be heart shaped, but could be any general shape including diamonds so long as the actuation bars are staggered and all attach along a line that passes through the living hinge at the bottom of the cams.

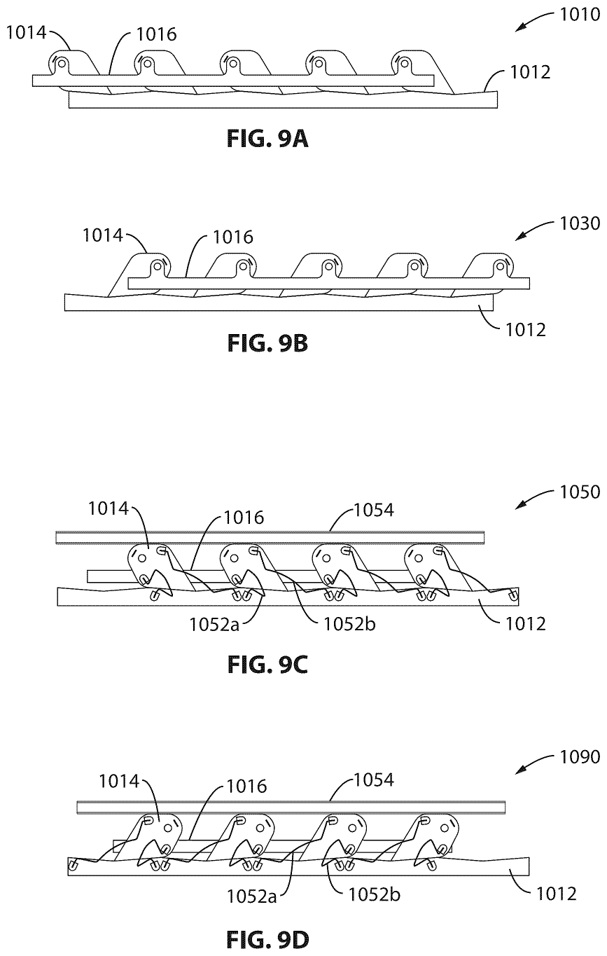

FIG. 9A through FIG. 9D illustrates a fabricated embodiment of a cam strip utilizing diamond-shaped cams 1014 attached to base 1012, and using an actuation bar 1016. In this example the revolute joints at the base of the diamond-shaped cams were fabricated as living hinges.

In FIG. 9A and FIG. 9B is shown one side of the cam strip with the cams shown in their left-leanings stable position 1010, and right-leanings stable position 1030.

In FIG. 9C and FIG. 9D is shown the other side of the cam strip with the cams shown in their left-leanings stable position 1050, and right-leanings stable position 1090. On this side of the linkage are shown the inclusion of optional balancing springs 1052a, 1052b, with these springs under load 1054 leaning left and leaning right.

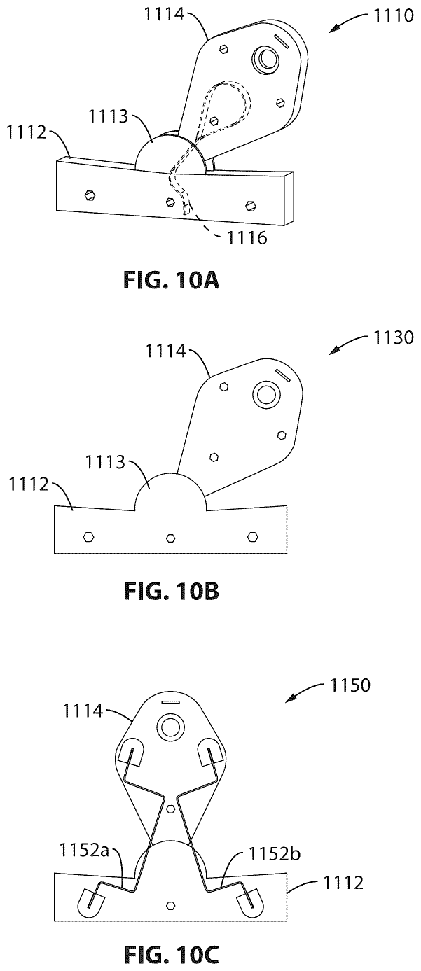

FIG. 10A through FIG. 10C illustrate an embodiment of a cam 1114 attached to its base 1112 with a living hinge 1116. In FIG. 10A the living hinge 1116 is made from a flexible material, such as a stretch-resistant strap of fabric which connects the cam to the base. The fabric strap being retained in any desired manner in both the cam and the base.

The strap may be a separate strap piece for each cam, and be configured for fastening at each end. For example, a fabric loop may be made which is routed around a structure in the cam (as shown) and/or the base. In FIG. 10A the fabric is shown looping around a post inside the cam.

In another implementation, the fabric strap is one continuous strap that passes into the base, up into the cam and loops back down into the base and can be routed to other cams as well. The present disclosure is not limited as to the mechanism for routing and retention of the strap, as it will be appreciated that in view of the present disclosure numerous means are available for both routing and attaching of straps.

The embodiment of FIG. 10A through FIG. 10C also illustrate the use of optional support walls 1113 to reduce any possible off-axis movement of the cam in response to unwanted off-axis loading. The figure depicts two semi-circular support walls extending from each side of the base, between which the pointed end of the cam is slidably retained. In the example shown the pointed end of the cam is profiled as seen in FIG. 10B, so that the remaining outer surface of the cam and the outer surface of the base are substantially flush, and which provides a semicircular ‘track’ upon which the step in the cam, from smaller width to full width, rides. It should, however, be appreciated that the support may be configured in numerous ways without departing from the present disclosure. For example, the support walls may extend from the outside of the base, and thus not require the cam shape to be stepped down at its hinged tip. The support walls can even be made to extend from the cam to overlap this portion of the base. Thus, the disclosure anticipates various forms of support wall structure to prevent the living hinge from experiencing unwanted off-axis loads when a person lies on top, and/or to improve guiding cam motions along its travel path. In FIG. 10C, the backside of the cam strip is shown with the addition of balancing springs 1152a, 1152b.

Furthermore, in at least one implementation, the straps may be formed integrally within the cam and/or base by, for example, using a process in which the strap is molded in-situ (i.e., injection molded) into the cam, or into the base, or more preferably into both the cam and the base at once, thus reducing the need for additional assembly processes. In the case of this type of molding process, the portions of the strap to be retained may be configured with apertures through which the plastic injects thereby assuring retention without any possibility of slipping.

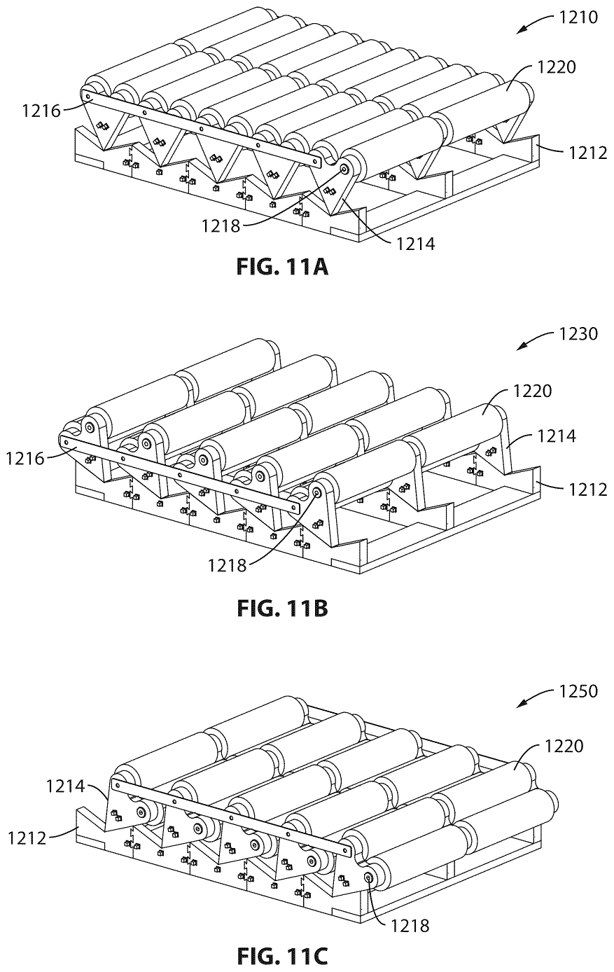

FIG. 11 through FIG. 11C illustrate an embodiment in which the rocking cams in adjacent cam strips are arranged in-phase and bars are added to connect these orthogonally located cams. The figures depict this implementation in a center position 1210 in FIG. 11A, in a full left-leaning position 1230 in FIG. 11B, and in a full right-leaning position 1250 in FIG. 11C. It should be appreciated that this embodiment may incorporate static balancing springs, such as shown and described in other embodiments herein.

In each figure is shown cams 1214 hinged to base 1212, and having an actuation bar 1216, as was already seen in FIG. 1A, and other figures using the heart-shaped cams. However, this figure also shows that column bars 1218 connect to, or through, the holes from cam to cam, and over which is retained a cylindrical pad 1220. It should also be appreciated that between the column bar 1218 and the pad 1220, may be an intermediate material, such as a plastic sleeve, to provide spacing between the cams and to extend the exterior, so that only a desired amount of cylindrical padding is required.

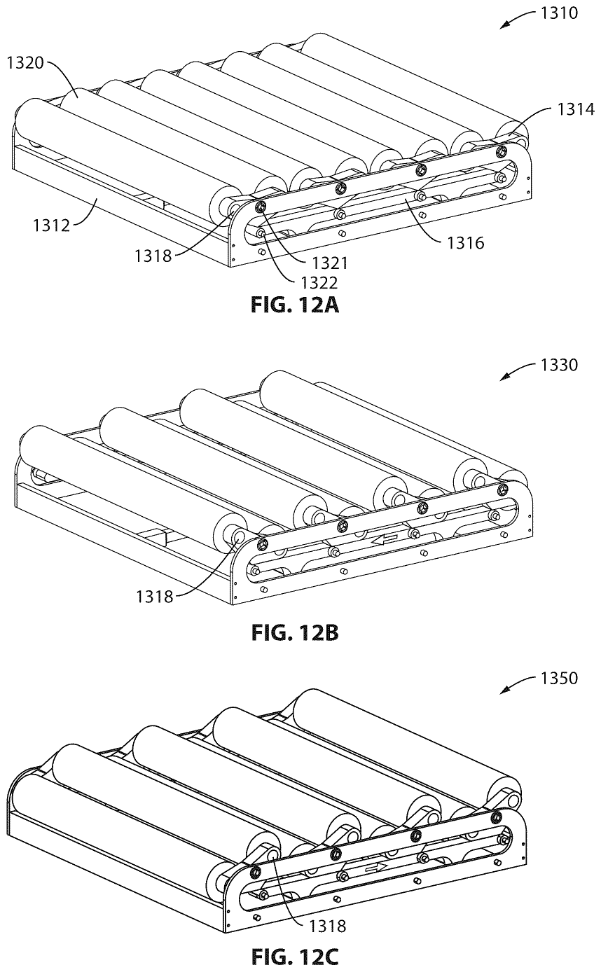

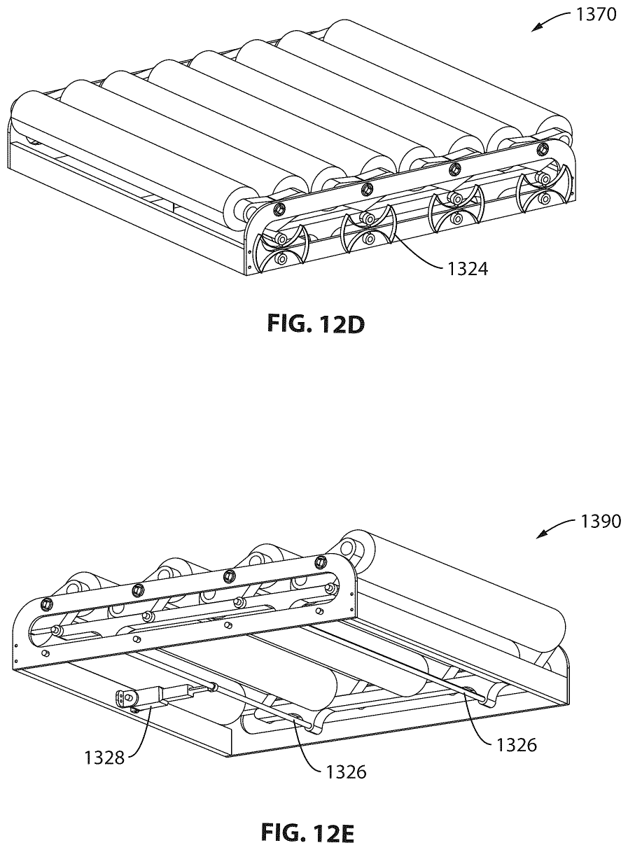

The in-phase cams tied with bars and cylindrical pads provide a support surface that can alternate lateral or longitudinal pressure patterns by shifting the rocking cams center, left or right. In the embodiment of FIG. 11A through FIG. 11C the patient moves horizontally with the cam while for the embodiment of FIG. 12A through FIG. 12E the patient moves vertically with the cam. In the embodiments of FIG. 12A through FIG. 12E, as described in the next section, the mattress and patient would remain stationary and the pressure point altered for achieving RCAP without rocking the patient from side to side.

It should be appreciated that although the cam strips seen in FIG. 7A and FIG. 7B and FIG. 8A through FIG. 8E, can be arranged out of phase from one linkage to the next, so that the resulting support surface achieves an alternating checkerboard-like pressure pattern, different pressure patterns can be achieved by arranging the cams in phase as shown in FIG. 11A through FIG. 11C.

Such in-phase designs can require fewer linkages and achieve alternating lateral or longitudinal pressure patterns if bars 1218 are used to join the in-phase cams together. Cylindrical pads made of various materials (e.g., foam, gel, or inflated cushions) can be slid onto those bars to provide large areas of compliant supports to reduce the peak pressures imparted on persons lying or sitting on top of the support surface. Such cylindrical pads could also be made into shorter segments and slid onto the bars with spacers in between to achieve different pressure patterns. For instance, in areas that typically experience the highest pressures (e.g., underneath the sacrum) the pads can be configured in any desired manner toward reducing such peak pressure.

It will be noted that the actuation bars in FIG. 11A through FIG. 11C are connected at a different location on the cams, in particular being shown lined up with one of the bar retention holes. There are tradeoffs on actuation bar location. The higher the bars are located on the cams, the less force is required to move them, but the distance they must move in traversing their range of motion increases. However, the actuation bar must not be so high that any portion of the persons weight is resting on the actuation bars. Basically, so long as actuation bars are attached to the same locations on the rocking cams they can be actuated to the full range of motion. As with the other embodiments, balancing springs can be attached, such as along the sides of the support surface to counteract the weight of the person so that it requires minimal actuation energy to alternate between the different cam positions. Also, as in the other embodiments, one or more actuators, can be attached to actively cause cam movement in an automatic (e.g., timed), or semi-automatic (e.g., press of a button) manner.

FIG. 12A through FIG. 12E illustrate an alternative implementation of the padded bars shown in FIG. 11A through FIG. 11C. The heart shaped cams 1314 have a slightly different shape. Adjacent rows of cams are connected by column bars 1218 connecting to, or through, the holes from cam to cam, and over which is retained a cylindrical pad 1320.

In this variation, shown with views 1310, 1330, 1350, 1370 and 1390, the actuation bar of the previous design is held fixed as the new base, and the base of the previous design is driven as the new actuation bar, alternating lateral or longitudinal pressure patterns can be created without requiring that the person lying or sitting on top move with the top surface. The balancing spring 1324 in FIG. 12E may be implemented as a spring mechanism of any shape made of single, dual or plurality of springs, which are under load in the central state and bias the cams to the left or right positions.

Specifically, FIG. 12A through 12E depicts lobed cams, which by way of example are squatty (vertically shortened) heart-shaped cams 1314, which are attached at an upper pivot point (revolute joint) 1321 to base 1312. An actuator bar 1316 is connected at a revolute joint 1322 to each of the cams on this side. A coupling structure 1326 in seen in FIG. 12E on the underside for coupling the actuator bar on the first side to the actuator bar on the second side. By way of example and not limitation, this coupling structure is depicted as rods connecting between the two sides.

When the actuation bar 1316 is moved to the left then the rollers leans to the right as seen in FIG. 12B, and when the actuation bar is moved to the right then the rollers lean to the left as seen in FIG. 12C, whereby the pressure pattern on the person is alternated.

In FIG. 12D is also shown the use of balancing springs 1324 attached between the base 1312 and actuation bar 1316, toward biasing the cams to their left or right positions. The energy required to actuate the actuation bar left and right with a person lying or sitting on top can be minimized dramatically by leveraging these pre-compressed balancing springs attached to the sides of the support surface.

In FIG. 12E an actuator 1328 is shown being attached between the base 1312 and coupling structure 1326 connecting the actuation bar 1316. The actuator allows leveraging mechanical advantage to further reduce the actuation effort to alternate the pressure, such as in an automatic, or semi-automatic manner.

In this design the lateral or longitudinal pressure pattern is alternated on the person without them shifting. It should be noted that the implementations in FIG. 11A through FIG. 11C, and FIG. 12A through FIG. 12E, as well as the other embodiments of the present disclosure, can be implemented into various RCAP support structures, such as full mattresses or into smaller mattress segments, seat cushions (e.g., wheelchair cushions), or other items in which it is important to alter the applied pressure pattern.

### 3. General Scope of Embodiments

From the description herein, it will be appreciated that the present disclosure encompasses multiple implementations of the technology which include, but are not limited to, the following:

A cam strip apparatus, comprising: (a) a base; (b) a plurality of rocking cams, each said rocking cam pivotally coupled to said base by a first revolute joint, wherein said first revolute joint allows the rocking cam to rock between at least a first stable position and a second stable position; (c) an actuation bar, each said rocking cam pivotally coupled to said actuation bar by a second revolute joint, wherein in response to movement of the actuation bar the rocking cams move in unison between a first position and a second position, and wherein a pressure profile on a support surface overlying said cam strip apparatus is altered by movement of the rocking cams; and (d) wherein said cam strip apparatus is configured for being retained in series and/or parallel with other cam strips apparatus to extend width and/or length of the support surface.

The apparatus or method of any preceding or following implementation, wherein each of said rocking cams comprises a geometric shape which provides a differently positioned point of contact on the support surface when it is angularly displaced between leaning in a first direction to leaning in a second direction.

The apparatus or method of any preceding or following implementation, wherein said geometric shape comprises a cardioid shape.

The apparatus or method of any preceding or following implementation, wherein said geometric shape comprises a rounded diamond shape.

The apparatus or method of any preceding or following implementation, wherein said base is configured for supporting each of said plurality of rocking cams in a first stable contact position with said base on a first side of said first revolute joint, and a second stable contact position with said base on a second side of said first revolute joint.

The apparatus or method of any preceding or following implementation, wherein said base has stops, located at the first and second stable contact positions, to limit the angular travel of each rocking cam.

The apparatus or method of any preceding or following implementation, further comprising a connector handle connected to the actuation bar, wherein pulling or pushing the connector handle changes the position of the actuation bar, and wherein the connector handle is configured to be connected to a plurality of actuation bars.

The apparatus or method of any preceding or following implementation, further comprising a strap retaining structure on each rocking cam, said strap retaining structure configured for interconnecting rocking cams in adjacent cam strip apparatuses so that all interconnected rocking cams move in unison.

The apparatus or method of any preceding or following implementation, further comprising a power driven actuator connected to the actuation bar to move the cams to a desired angular position.

The apparatus or method of any preceding or following implementation, further comprising balancing springs at one or more locations in the cam bar apparatus to bias the rocking cams to a central position and thus reduce force required at the actuation bar to move the rocking cams to a desired angular position.

The apparatus or method of any preceding or following implementation, further comprising support walls between the base and the rocking cams that prevent off-axis movements of the rocking cams.

The apparatus or method of any preceding or following implementation, wherein said cam strip apparatus is configured for being utilized with adjacent cam strip apparatuses in a phased relationship to create a striped pressure pattern.

The apparatus or method of any preceding or following implementation, wherein said cam strip apparatus is configured for being utilized with adjacent cam strip apparatuses in an out-of-phase relationship to create an alternating checkerboard-like pressure pattern.

The apparatus or method of any preceding or following implementation, wherein said rocking cams, said base, and said actuation bar comprise a single cam strip component, and wherein said actuation bar comprises bar segments between pairs of rocking cams and are staggered from one pair of rocking cams to the next.

The apparatus or method of any preceding or following implementation, wherein said rocking cam are configured for retaining column bars which connect to rocking cams in adjacent cam strips so that the rocking cams attached to the column bars, move in unison in response to movement of the actuation bar.

The apparatus or method of any preceding or following implementation, wherein said cam strip apparatus is configured for being attached to a cam strip frame, along with additional cam strip apparatuses, to span a desired length and a desired width of a desired area to be supported.

The apparatus or method of any preceding or following implementation, wherein said cam strip frame contains multiple revolute joints to allow the cam strip frame to flex in fitting a specific support surface application.

A rocking cam apparatus, comprising: (a) a plurality of cam strips, each said cam strip comprising: (a)(i) a base; (a)(ii) a plurality of rocking cams, each said rocking cam pivotally coupled to said base by a first revolute joint, wherein the first revolute joint allows the rocking cam to rock between at least a first stable position and a second stable position; (a)(iii) an actuation bar, each said rocking cam pivotally coupled to the actuation bar by a second revolute joint, wherein in response to movement of the actuation bar the rocking cams move in unison between a first position and a second position, and wherein a pressure profile on a support surface overlying said cam strip apparatus is altered by movement of the rocking cams; and (b) a cam strip connection frame configured to retain multiple said cam strips in series and/or parallel connection with each other and the connection frame to span a desired width and/or a desired length to cover a desired support surface.

The apparatus or method of any preceding or following implementation, wherein said cam strip frame contains multiple revolute joints to allow the cam strip frame to flex in fitting a specific support surface application.

The apparatus or method of any preceding or following implementation, further comprising column bars which connect to rocking cams in adjacent cam strips so that the rocking cams attached to the column bars move in unison in response to movement of the actuation bar.

The apparatus or method of any preceding or following implementation, further comprising a cylindrical pad on said column bars.

A rocking cam apparatus, comprising: (a) a plurality of cam strips, each said cam strip comprising: (a)(i) a base; (a)(ii) a plurality of cams, each said cam having two lobes, each said cam pivotally attached at an upper pivot, between the lobes of the cam, to said base, wherein at the bottom of each cam is a lower pivot joint configured for receiving actuation pressure for rotating the cam; (a)(iii) two column bars connecting between the lobes of each cam to the lobes of a cam on an adjacent cam strip so that the cams attached to the column bars move in unison; (a)(iv) an actuation bar attached to lower pivot joints across a number of said cams, wherein in response to movement of the actuation bar, the cams move in unison between a first position and a second position, thus altering the pressure profile on a surface overlying said cam strip; and (b) a cam strip connection frame configured to retain multiple said cam strips in series and/or parallel connection with each other and the connection frame to span a desired width and/or a desired length to cover a desired support surface.

The apparatus or method of any preceding or following implementation, further comprising balancing springs at one or more locations spanning the actuation bar and the base to bias the cams to left or right positions, wherein force required at the actuation bar to move the cams to a desired angular position is reduced.

The apparatus or method of any preceding embodiment wherein the apparatus is used to increase a person's comfort, reduce or prevent pressure injuries, provide massage therapy, or provide side-to-side rocking motion which comforts the person to the person sleep or to calm the person.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1 %, less than or equal to ±0.5%, less than or equal to ±0.1 %, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A cam strip apparatus, comprising:
(a) a base;
(b) a plurality of rocking cams, each said rocking cam pivotally coupled to said base by a first revolute joint, wherein said first revolute joint allows the rocking cam to rock between at least a first stable position and a second stable position;
(c) an actuation bar, each said rocking cam pivotally coupled to said actuation bar by a second revolute joint, wherein in response to movement of the actuation bar the rocking cams move in unison between a first position and a second position, and wherein a pressure profile on a support surface overlying said cam strip apparatus is altered by movement of the rocking cams; and
(d) wherein said cam strip apparatus is configured for being retained in series and/or parallel with other cam strips apparatus to extend width and/or length of the support surface.

2. The apparatus of claim 1, wherein each of said rocking cams comprises a geometric shape which provides a differently positioned point of contact on the support surface when it is angularly displaced between leaning in a first direction to leaning in a second direction.

3. The apparatus of claim 2, wherein said geometric shape comprises a cardioid shape.

4. The apparatus of claim 2, wherein said geometric shape comprises a rounded diamond shape.

5. The apparatus of claim 1, wherein said base is configured for supporting each of said plurality of rocking cams in a first stable contact position with said base on a first side of said first revolute joint, and a second stable contact position with said base on a second side of said first revolute joint.

6. The apparatus of claim 5, wherein said base has stops, located at the first and second stable contact positions, to limit the angular travel of each rocking cam.

7. The apparatus of claim 1, further comprising a connector handle connected to the actuation bar, wherein pulling or pushing the connector handle changes the position of the actuation bar, and wherein the connector handle is configured to be connected to a plurality of actuation bars.

8. The apparatus of claim 1, further comprising a strap retaining structure on each rocking cam, said strap retaining structure configured for interconnecting rocking cams in adjacent cam strip apparatuses so that all interconnected rocking cams move in unison.

9. The apparatus of claim 1, further comprising a power driven actuator connected to the actuation bar to move the cams to a desired angular position.

10. The apparatus of claim 1, further comprising balancing springs at one or more locations in the cam bar apparatus to bias the rocking cams to a central position and thus reduce force required at the actuation bar to move the rocking cams to a desired angular position.

11. The apparatus of claim 1, further comprising support walls between the base and the rocking cams that prevent off-axis movements of the rocking cams.

12. The apparatus of claim 1, wherein said cam strip apparatus is configured for being utilized with adjacent cam strip apparatuses in a phased relationship to create a striped pressure pattern.

13. The apparatus of claim 1, wherein said cam strip apparatus is configured for being utilized with adjacent cam strip apparatuses in an out-of-phase relationship to create an alternating checkerboard-like pressure pattern.

14. The apparatus of claim 1, wherein said rocking cams, said base, and said actuation bar comprise a single cam strip component, and wherein said actuation bar comprises bar segments between pairs of rocking cams and are staggered from one pair of rocking cams to the next.

15. The apparatus of claim 1, wherein said rocking cam are configured for retaining column bars which connect to rocking cams in adjacent cam strips so that the rocking cams attached to the column bars, move in unison in response to movement of the actuation bar.

16. The apparatus of claim 1, wherein said cam strip apparatus is configured for being attached to a cam strip frame, along with additional cam strip apparatuses, to span a desired length and a desired width of a desired area to be supported.

17. The apparatus of claim 16, wherein said cam strip frame contains multiple revolute joints to allow the cam strip frame to flex in fitting a specific support surface application.

18. A rocking cam apparatus, comprising:
(a) a plurality of cam strips, each said cam strip comprising:
(i) a base;
(ii) a plurality of rocking cams, each said rocking cam pivotally coupled to said base by a first revolute joint, wherein the first revolute joint allows the rocking cam to rock between at least a first stable position and a second stable position;
(iii) an actuation bar, each said rocking cam pivotally coupled to the actuation bar by a second revolute joint, wherein in response to movement of the actuation bar the rocking cams move in unison between a first position and a second position, and wherein a pressure profile on a support surface overlying said cam strip apparatus is altered by movement of the rocking cams; and
(b) a cam strip connection frame configured to retain multiple said cam strips in series and/or parallel connection with each other and the connection frame to span a desired width and/or a desired length to cover a desired support surface.

19. The apparatus of claim 18, wherein said cam strip frame contains multiple revolute joints to allow the cam strip frame to flex in fitting a specific support surface application.

20. The apparatus of claim 18, further comprising column bars which connect to rocking cams in adjacent cam strips so that the rocking cams attached to the column bars move in unison in response to movement of the actuation bar.

21. The apparatus of claim 20, further comprising a cylindrical pad on said column bars.

22. A rocking cam apparatus, comprising:
(a) a plurality of cam strips, each said cam strip comprising:
(i) a base;
(ii) a plurality of cams, each said cam having two lobes, each said cam pivotally attached at an upper pivot, between the lobes of the cam, to said base, wherein at the bottom of each cam is a lower pivot joint configured for receiving actuation pressure for rotating the cam;
(iii) two column bars connecting between the lobes of each cam to the lobes of a cam on an adjacent cam strip so that the cams attached to the column bars move in unison;
(iv) an actuation bar attached to lower pivot joints across a number of said cams, wherein in response to movement of the actuation bar, the cams move in unison between a first position and a second position, thus altering the pressure profile on a surface overlying said cam strip; and
(b) a cam strip connection frame configured to retain multiple said cam strips in series and/or parallel connection with each other and the connection frame to span a desired width and/or a desired length to cover a desired support surface.

23. The apparatus of claim 22, further comprising balancing springs at one or more locations spanning the actuation bar and the base to bias the cams to left or right positions, wherein force required at the actuation bar to move the cams to a desired angular position is reduced.
